(19) United States
(12) Patent Application Publication
(10) Pub. No.: US 2023/0225243 A1
(43) Pub. Date: Jul. 20, 2023

(54) IMPROVEMENT APPLIED TO AGRICULTURAL EQUIPMENT

(71) Applicant: AGROTRITUS LOCACAO E COMERCIO EIRELI, Curitiba (BR)

(72) Inventor: Manuel Ribeiro, Curitiba (BR)

(21) Appl. No.: 18/009,196

(22) PCT Filed: Nov. 5, 2020
(86) PCT No.: PCT/BR2020/050456

§ 371 Date: Dec. 8, 2022

(30) Foreign Application Priority Data
Jun. 9, 2020 (BR) BR202020011537-0

(51) Int. Cl. A01D 34/43; A01G 3/00; A01D 34/54; A01D 34/62

(52) U.S. Cl. CPC A01D 34/43; A01D 34/54; A01D 34/62; A01G 3/002

(57) ABSTRACT

A woody vegetation suppressor equipment, being a forest implement, for the grinding of woody vegetation, bushes, grass, stumps and pruning remains; it is composed by a metallic structure all reinforced in steel, with a hitch on the three points of the tire tractor, drive cardan, bidirectional transmission box with lateral transmission made with belts and pulleys and at the bottom an axle with displaced knives; the equipment is coupled in the front part in a tire tractor, where it is driven by the tractor’s power take-off, the power take-off turns in high rotation through the main and secondary transmission, drives the cutting system making the axle underneath the equipment that is equipped with cutting blades reach a high torque, being able to shred all the vegetation that comes in contact. The benefit is to mechanize the process of clearing vegetation, using shredding, providing a faster and more environmentally friendly operation.

### FIELD OF APPLICATION

1. The said equipment, whose protection will be claimed in this report, was developed with the intention of overcoming deficiencies, mitigating difficulties, and solving problems until then encountered by users in the sector, more precisely, in the agricultural, forestry, and livestock sectors.

### INTRODUCTION

2. Performing vegetation suppression works with high productivity in forest areas is a complex task that demands the maximum care with the environment. Forestry shredders from the holder of the patent application described here provide total control of the processes, reducing the large amount of manual labor, reducing costs and time, fundamental elements in successful projects. They also eliminate burning and use shredded material to conserve organic matter, being in total harmony with the environment.

3. Shredder from the holder shreds the vegetation instead of burning it; it enriches the soil with organic nutrients from the shredded plant material; the technology replaces the work of 15 people and avoids the risk of accidents and animal bites; and it connects the shredder to the tractor and starts using it right away.

4. Forestry Shredder is a machine that unites the cleaning of forest areas with environmental care. It is being used in the most diverse tasks, such as: cleaning pastures, bushes, orange trees, coffee and tea trees, cleaning stumps in reforestation, among others. It is also very efficient for cleaning electric lines.

5. Present Utility Model patent request refers to a woody vegetation suppressor equipment, being a forest implement, whose function consists in acting in the grinding of woody vegetation, bushes, grass, stumps, and pruning remains.

6. Essentially, the mentioned equipment stands out for the most practical, simple and functional form in an equipment developed to act in the grinding of woody vegetation, bushes, grass, stumps and pruning remains, being the same endowed with unique, exclusive and innovative functional aspects, which will be described next, becoming an exclusive equipment in the market.

### CHARACTERISTICS

7. The equipment in question, presented by means of this report, is composed of: an all steel reinforced metallic structure, with a hitch on the three points of the tire tractor, drive cardan, bidirectional transmission box with lateral transmission made with belts and pulleys and in the lower part an axle with displaced positioned knives. FIGURES:

8. Initially, to better demonstrate such characteristics, and aiming at a clear and objective understanding about the provisions applied in the present utility model, a drawing and flowchart will be presented in a demonstrative character, making references to the report that are attached.

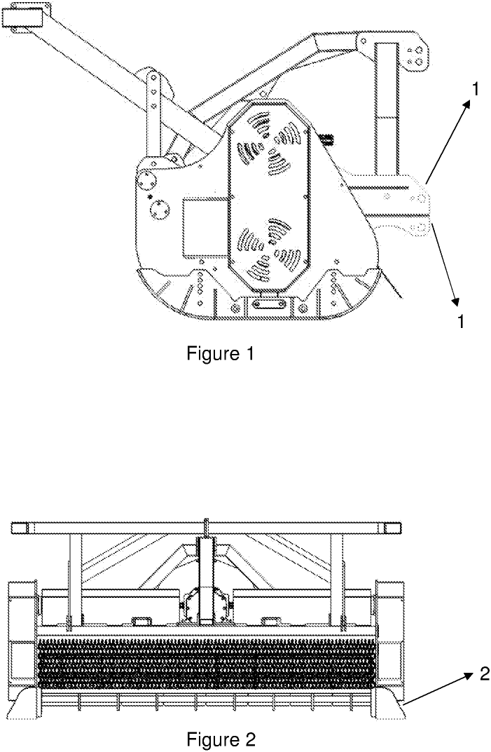

9. FIG. 1 illustrates the equipment in side view, emphasizing: the standardized hitch (1) with two height options, facilitating the interchangeability of the tractors.

10. FIG. 2 illustrates, in a rear view, the equipment, emphasizing: the ski with a curved angle (2) to deviate the stumps, thus avoiding stubbing.

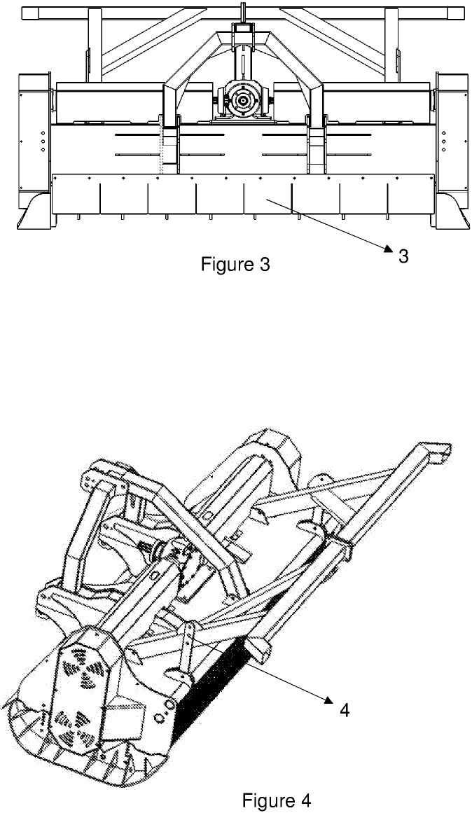

11. FIG. 3 illustrates, in front view, the equipment, emphasizing: the segmented rubber protection (3) at the rear of the equipment, which can move individual segments.

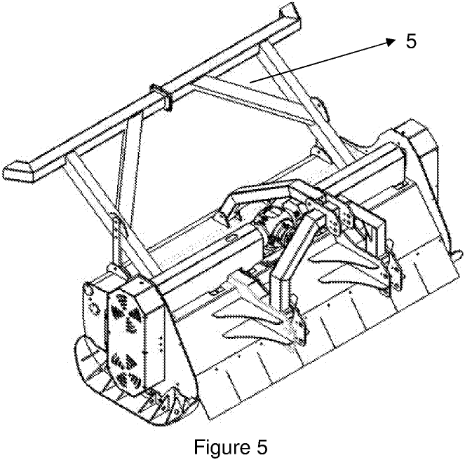

12. FIG. 4 illustrates, in perspective view, the equipment, emphasizing: the push arm with three height adjustments (4) that can adapt to various types of vegetation.

13. FIG. 5 illustrates, in perspective view, the equipment, emphasizing: the “French hand” type reinforcement (5) on the pushing arm, stabilizing the equipment when forced against vegetation.

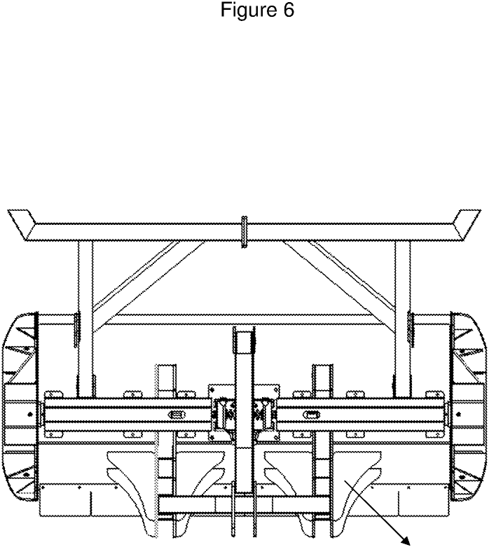

14. FIG. 6 illustrates, in top view, the equipment, emphasizing: the quadruple lateral reinforcement (6) to ensure the integrity of the tractor’s hitch arm.

15. It is worth clarifying that the images listed above illustrate the equipment in a demonstrative and not restrictive character, whose conception may vary as to its measures, raw material, dimensions, etc, without logically escaping, from the main scope whose protection is claimed.

### FUNCTIONALITY

16. Initially the referred equipment, described by means of this report, will be used in the agricultural, forestry and livestock sectors.

17. Equipment is indicated for: lowering pine and eucalyptus stumps; cleaning branches for the forestry and cellulose industry; eradicating coffee and orange plantations at the end of their useful life; opening and maintaining tracks on electric and telephone lines; opening and maintaining gas and oil pipelines; building and maintaining roadsides; cleaning land; preventing forest fires; and expanding agricultural and cattle-raising areas.

18. Equipment is coupled in the front part on a tire tractor, where it is driven by the tractor’s power takeoff, the power takeoff rotates in high rotation through the main and secondary transmission, drives the cutting system making the shaft under the equipment that is equipped with cutting blades reach a high torque, being able to shred all the vegetation that comes in contact with it.

### INNOVATION

19. In general terms, the referred equipment represents a solution in what concerns a woody vegetation suppressor equipment, acting in the shredding of woody vegetation, bushes, grass, stumps and pruning remains.

20. Standardized hitch (1) with two height options, facilitating the interchangeability of the tractors, side skis with higher attack angle, allowing the follow up of the terrain and reducing the tractor’s effort.

21. Pushing arm with three height adjustments (4), which can adapt to various types of vegetation, quadruple lateral reinforcement (6) to ensure the integrity of the tractor hitch arm and ski with a curved angle (2) to divert the stubs, thus preventing locking.

22. Segmented rubber protection (3) at the rear of the equipment, being able to move individual segments and “French hand” type reinforcement (5) on the push arm, thus stabilizing the equipment when forced against vegetation.

23. The benefit is to mechanize the process of clearing vegetation, using shredding instead of traditional burning, providing a faster and more environmentally friendly operation, and an increase in productivity compared to traditional methods.

24. Equipment comes to solve burning problems, besides contributing to the enrichment of the soil with shredded matter.

25. It is a unique, exclusive, and innovative piece of equipment, being highly reliable and recommended for use when cleaning pastures, hedges, orange trees, coffee and tea trees, stump cleaning in reforestation, among others, being also very efficient for forest cleaning of electric lines and will certainly be a great differentiator for the sector to which it is intended.

### DESCRIPTION OF THE STATE OF THE ART

26. During the development of the mentioned equipment, numerous surveys were conducted to identify the existence of possible precedents or related equipment. Such surveys, however, have not indicated the existence of any other equipment with the same preponderant technical or functional characteristics.

27. There are imported machines that their deficiencies with this new equipment of the applicant consist in the cutting system that is not very efficient, the cutting system used in the applicant’s equipment are cutting blades that are much more efficient if compared with the competitors, because they only crush the vegetation, while the cutting system of the patent request under analysis cuts.

28. Process presented in patent application BR 10 2017 003280 9 at the INPI (National Institute of Industrial Property), refers to a shredder implement of vegetation or plant remains, intended for the agricultural sector, as a way to completely abolish the use of fire in agriculture, incorporating organic matter to the soil in an ecological and economical way, comprising improvements in the material of knives and counter-knives; Self-aligning roller bearings and bearings specially shaped for this type of bearing; Additional protection of chains against debris; Addition of joints at the output of the transmission box; Rigid chassis; 5-channel matched pulley and belt system, type B63; Side skis with reinforcements; Advance arm; Input expander; and, Design with system-fit layout.

29. Process presented in the application for patent BR 20 2016 017632 3 in INPI (National Institute of Industrial Property), refers to an equipment to grind bushes up to medium-sized trees which is crushed, and so far, there is no equipment that performs the grinding of waste, cleaning and preparation of areas to be cultivated, for such activities are needed various equipment, specific for each task; thus, in an innovative configuration, the object of the present patent request is constituted from a horizontal chassis that has in the center of its upper part a transmission box, which has an input shaft in the front part and two output shafts, one in each side, in which the transmission shafts are connected, and in whose extremities pulleys are attached; these are connected to the lower pulleys by means of belts, and these lower pulleys are connected to the ends of a cutting rotor, positioned in the lower portion of the chassis and above the chassis, and at the ends there are two “L” shaped arms, opposed, and in the center a frame that has a “U” shape, and finally, on the rear face of the chassis there is a chain curtain.

30. Process mentioned in paragraph 28 refers to the state of the art existing in the respective segment, considerable useful to the search and understanding, being that the process BR 10 2017 003280 9 does not contain standardization and does not count with two options of coupling; the process BR 10 2017 003280 9 has its lower angle of attack, where there is a higher incidence of vegetation entanglement; the process BR 10 2017 003280 9 does not have a curved angle in the ski but a straight one, not deviating from the stumps when necessary; the process BR 10 2017 003280 9 uses chain, blocking less residue than rubber; the process BR 10 2017 003280 9 does not have four side reinforcements, only two and small reinforcements; and the process BR 10 2017 003280 9 does not have the “French hand” that stabilizes the equipment when forced against the vegetation.

31. Process mentioned in paragraph 29 refers to the state of the art existing in the respective segment, considerable useful to the search and understanding, whereas the patent registration request reported through this report is different because it contains a standardized hitch (1) with two height options facilitating the interchangeability of the tractors, side skis with a higher angle of attack, allowing the follow up of the terrain and reducing the tractor’s effort; push arm with three height adjustments (4), which can adapt to various types of vegetation, quadruple side reinforcement (6) to ensure the integrity of the tractor hitch arm, ski with curved angle (2) to deviate the stubs avoiding locking; segmented rubber protection (3) at the rear of the equipment, being able to move individual segments and reinforcement “French hand” type (5) in the push arm, thus stabilizing the equipment when forced against the vegetation.

32. In view of this need and commercial opportunity, the mentioned equipment was created, more precisely a woody vegetation suppressor equipment, being a forest implement, whose function consists on acting in the shredding of woody vegetation, bushes, grass, stumps, and pruning remains.

1. A woody vegetation suppressor equipment, being a forest implement comprising: standardized hitch (1) with two height options, located on the front part of the equipment.

2. The suppressor equipment of claim 1, further comprising: ski with a curved angle (2), located on the rear side of the equipment.

3. The suppressor equipment of claim 1, further comprising: segmented rubber protection (3), located in the rear part of the equipment.

4. The suppressor equipment of claim 1, further comprising: push arm (4) with three height adjustments, located in the upper rear part of the equipment.

5. The suppressor equipment of claim 1, further comprising: “French hand” type reinforcement (5) in the push arm, located in the upper part of the equipment.

6. The suppressor equipment of claim 1, further comprising: quadruple side reinforcement (6), located in the front part of the equipment.
